(19) United States
(12) Patent Application Publication
(10) Pub. No.: US 2024/0391048 A1
(43) Pub. Date: Nov. 28, 2024

(54) IN-TOOL AUDIO AND VISUAL BEHAVIOR MONITORING FOR PROCESS CONTROL

(71) Applicant: Applied Materials, Inc., Santa Clara, CA (US)

(72) Inventors: Justin H. WONG, Pleasanton, CA (US); Devin PON, Santa Clara, CA (US)

(21) Appl. No.: 18/321,895

(22) Filed: May 23, 2023

(51) Int. Cl. B24B 37/005; G06T 7/00; G06T 7/12

(52) U.S. Cl. CPC B24B 37/005; G06T 7/001; G06T 7/12; G06T 2200/24; G06T 2207/10016; G06T 2207/30148

(57) ABSTRACT

Embodiments of the disclosure provided herein include an apparatus and method for more efficient and effective in-tool monitoring of chemical mechanical polishing systems. The polishing apparatus includes a controller coupled to the at least one camera. The controller is configured to receive a media data stream from the at least one camera, process the media data stream into processed media data, and detect an anomaly in the polishing apparatus based on the processed media data. A method of monitoring a polishing apparatus includes receiving an image or audio data stream, processing the data stream, receiving a subsequent image or audio data stream, and comparing the second set of processed data to the first set of processed data.

### BACKGROUND

### Field

Embodiments of the present invention generally relate to chemical mechanical polishing (CMP) systems used in the manufacturing of semiconductor devices. In particular, embodiments herein relate to an in-tool audio and visual behavior monitoring system for use in CMP.

### Description of the Related Art

Chemical mechanical polishing (CMP) tools are commonly used in the manufacturing of semiconductor devices to planarize or polish a substrate, which involves the removal of excess material and surface imperfections. During a CMP process, a substrate is retained in a substrate carrier which presses the backside of the substrate towards a rotating polishing pad in the presence of a polishing fluid. Material is removed across the material layer surface of the substrate in contact with the polishing pad through a combination of chemical and mechanical activity which is provided by the polishing fluid and the relative motion of the substrate and the polishing pad.

During operations of these tools, hardware and process issues may arise, which can ultimately lead to tool failure if not addressed in a timely manner. Therefore, it is crucial to detect and analyze any deviations from the expected behavior of the CMP tools to ensure efficient and effective operation.

Accordingly, there is a need for improved in-tool monitoring for process control of CMP tools.

### SUMMARY

Embodiments described herein generally relate to systems and methods used for monitoring chemical mechanical polishing (CMP) systems used in the manufacturing of semiconductor devices. More particularly, embodiments herein provide for processes and methods for in-tool monitoring to allow efficient and effective operation.

In an embodiment, a polishing apparatus is provided. The polishing apparatus includes an arm rotatably secured to a base of the polishing apparatus, a conditioning head coupled to the arm and configured to rotate over a platen, at least one camera positioned within the polishing apparatus, and a controller coupled to the at least one camera. The controller includes a memory and a media analysis processor and is configured to receive a media data stream from the at least one camera, process the media data stream into processed media data, and detect an anomaly in the polishing apparatus based on the processed media data.

In another embodiment, a method of monitoring a polishing apparatus is provided. The method includes receiving a first image data stream from a camera disposed in the polishing apparatus, processing the first image data stream using a video analysis processor of a controller coupled to the polishing apparatus to produce a first set of processed image data, receiving a second image data stream from the camera, processing the second image data stream using the video analysis processor to produce a second set of processed image data, comparing the second set of processed image data to the first set of processed image data to determine if a predetermined threshold is exceeded, and upon determining that the predetermined threshold is exceeded, transmitting an alert to a user interface coupled to the controller.

In yet another embodiment, a method of monitoring a polishing apparatus is provided. The method includes receiving a first audio data stream from a camera disposed in the polishing apparatus, processing the first audio data stream using an audio analysis processor of a controller coupled to the polishing apparatus to produce a first set of processed audio data, receiving a second audio data stream from the camera, processing the second audio data stream using the audio analysis processor to produce a second set of processed audio data, comparing the second set of processed audio data to the first set of processed audio data to determine if a predetermined threshold is exceeded, and upon determining that the predetermined threshold is exceeded, transmitting an alert to a user interface coupled to the controller.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the present disclosure may admit to other equally effective embodiments.

FIG. 1A is a plan view of a polishing apparatus, according to one or more embodiments.

FIG. 1B is a schematic, partial cross-sectional side view of the polishing apparatus in FIG. 1A, according to certain embodiments.

FIG. 1C is a schematic, partial cross-sectional side view of the polishing apparatus in FIG. 1A, according to certain embodiments.

FIG. 2A illustrates a top-view of a polishing apparatus under an object contouring process, according to certain embodiments.

FIG. 2B illustrates a top-view of a polishing apparatus under an image segmentation process, according to certain embodiments.

FIG. 2C illustrates a top-view of a polishing apparatus under an image segmentation process, according to certain embodiments.

FIGS. 3A-3C are example spectrograms produced as part of monitoring a polishing apparatus, according to certain embodiments.

FIG. 4 illustrates schematic real-time control scheme to monitor a polishing apparatus, according to certain embodiments.

FIG. 5A shows a method to monitor a polishing apparatus, according to certain embodiments.

FIG. 5B shows a method to monitor a polishing apparatus, according to certain embodiments.

FIGS. 5C1-5C2 show a method to monitor a polishing apparatus, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to chemical mechanical polishing (CMP) systems used in the manufacturing of semiconductor devices. In particular, embodiments herein relate to an in-tool audio and visual behavior monitoring system for use in CMP.

Hardware and process issues in CMP systems are typically identified at the onset of failure. To ensure efficient and effective operation, it is crucial to analyze any deviations from expected tool behavior.

One way to understand failure modes is to capture audio and visual data during tool operation and review the captured audio and visual data after failure has occurred. Current implementations of video cameras, which capture visual data in substrate processing systems, are passive and mainly serve to provide a visual of the operation of the tool. Thus, user intervention is required to identify any deviations from expected tool behavior or environment.

Additionally, audio data analysis may be used to identify failures. Localized microphones may be used to collect audio data, which is then analyzed to identify abnormal sounds that may indicate hardware process issues. However, the data collected is often limited and focused on specific hardware components.

Accordingly, the present disclosure provides a technical solution to these problems by providing systems and methods to implement audio and visual data captured from CMP tools to assist in hardware health monitoring, tool excursions, and process control. The monitoring systems provide a camera system that relays video and audio streams from various portions of the CMP system to a consolidated data server. From this server, the monitoring system extracts the video and processes each image frame through trained algorithms. The monitoring systems also collect and analyze audio within the server. The collected video and audio data may be stored and retrieved to compare against later states of the system to monitor tool health as part of a machine learning algorithm. Advanced algorithms may be used on the collected video data to detect objects, misplaced components, or changes in color, indicating an abnormal state change within the CMP system. During real-time substrate processing, the collected video and audio data may be fed through an intermediary computer or processor, which may analyze the video frames and audio changes, allowing for real-time video detection of substrate polishing behavior, as well as audio to monitor for excursions, abnormalities, or even endpoint behavior.

The video and audio data streams may also be used to predict the onset of hardware and process problems, enabling predictive maintenance before tool failure. This process enables data collection on the CMP system to complement pre-existing data streams mined from sensors and motors. The resulting visual detection during CMP processing as well as tool condition monitoring enables improved tool health maintenance, tool cleanliness, and detection of foreign objects within the CMP system.

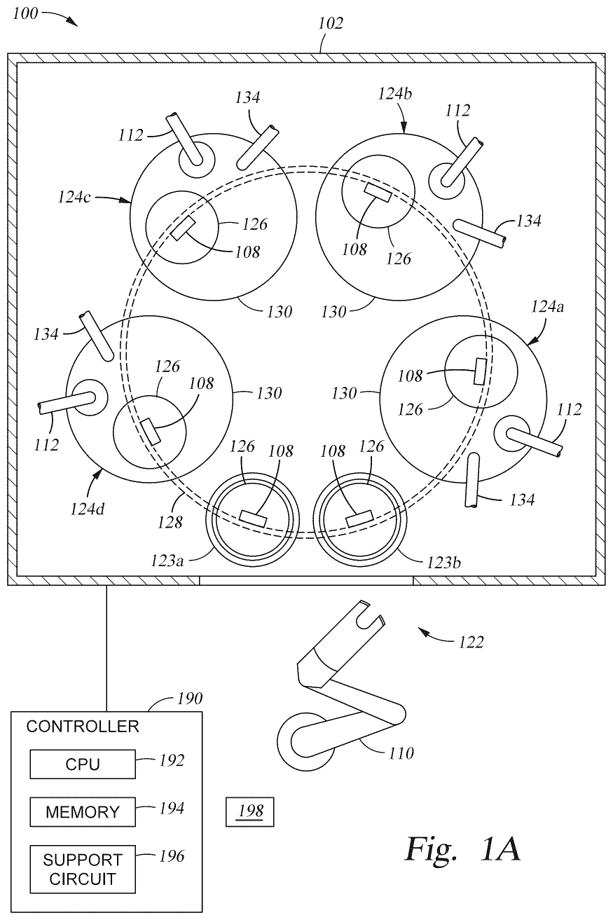

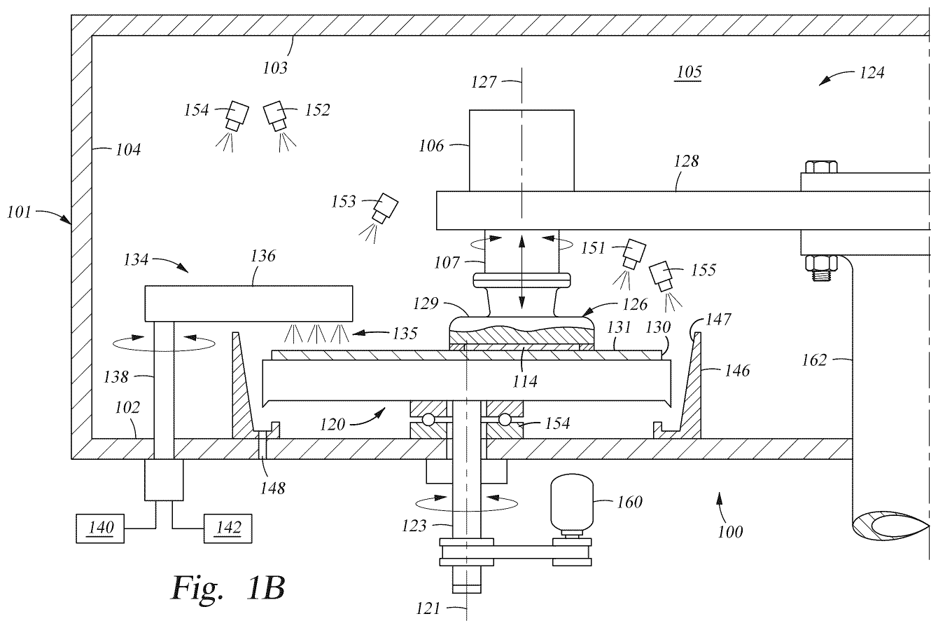

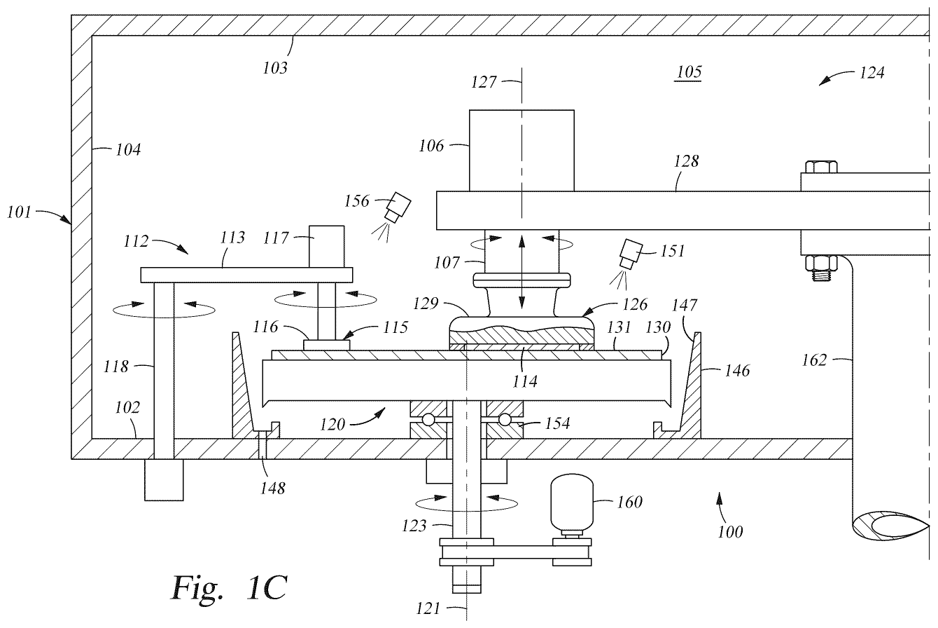

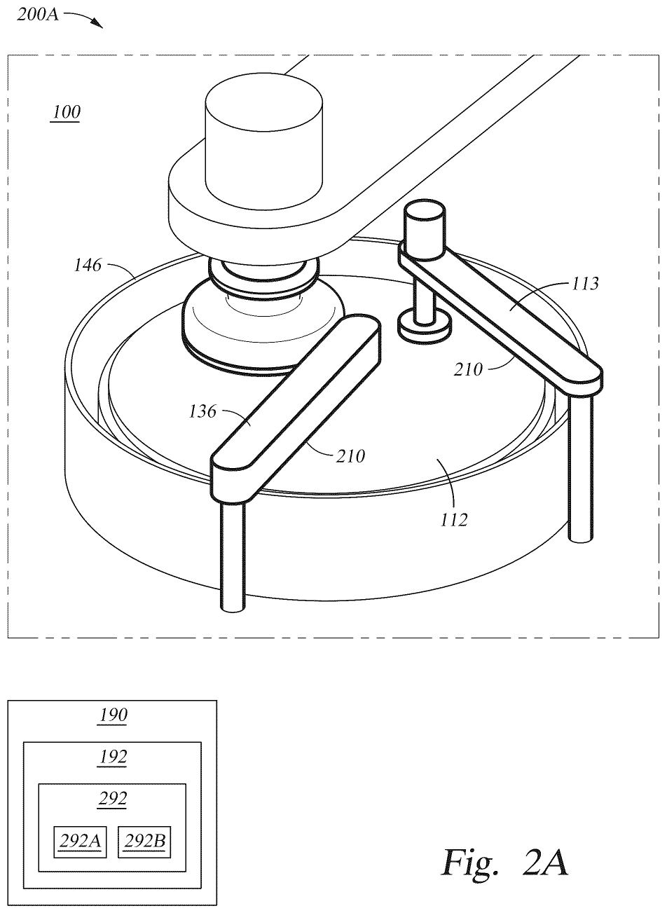

FIG. 1A is a plan view of a polishing apparatus 100, such as a chemical mechanical polishing (CMP) tool for processing one or more substrates. The polishing apparatus 100 includes a polishing platform, or base 102 that at least partially supports and houses a plurality of polishing stations 124. For example, the polishing apparatus 100 shown includes four polishing stations 124a, 124b, 124c and 124d. Each polishing station 124 is adapted to polish a substrate that is retained in a carrier head 126.

The polishing apparatus 100 also includes a plurality of carrier heads 126, each of which is configured to carry a substrate. The number of carrier heads 126 can be a number equal to or greater than the number of polishing stations 124, e.g., four carrier heads 126 or six carrier heads 126. For example, the number of carrier heads 126 can be two greater than the number of polishing stations 124. This permits loading and unloading of substrates to be performed from two of the carrier heads 126 while polishing occurs with the other carrier heads 126 at the remainder of the polishing stations 124, thereby providing improved throughput.

The polishing apparatus 100 also includes a transfer station 122 for loading and unloading substrates from the carrier heads 126. The transfer station 122 can include a plurality of load cups 123, e.g., two load cups 123a and 123b shown, adapted to facilitate transfer of a substrate between the carrier heads 126 and a factory interface (not shown) or other device (not shown) by a transfer robot 110. The load cups 123 generally facilitate transfer between the robot 110 and each of the carrier heads 126.

The stations of the polishing apparatus 100, including the transfer station 122 and the polishing stations 124, can be positioned at substantially equal angular intervals around the center of the base 102. This is not required, but can provide the polishing apparatus 100 with a reduced footprint.

Each polishing station 124 includes a polishing pad 130 supported on a platen 120 (shown in FIG. 1B). For a polishing operation, one carrier head 126 is positioned at each polishing station 124. Two additional carrier heads can be positioned in the transfer station 122 to exchange polished substrates for unpolished substrates while the other substrates are being polished at the polishing stations 124.

The carrier head 126 is adapted to hold a substrate against a polishing surface of the polishing pad 130, while relative motion is provided between the carrier head 126 and the platen 120 to polish the substrate. The relative motion may be rotational, lateral, or some combination thereof, and is provided by at least one of the carrier head 126 and the platen 120. Each carrier head 126 can have independent control of the polishing parameters, for example pressure, associated with each respective substrate.

The carrier heads 126 are held by a support structure that can cause each carrier head to move along a path that passes, in order, the first polishing station 124a, the second polishing station 124b, the third polishing station 124c, and the fourth polishing station 124d. This permits each carrier head to be selectively positioned over each of the polishing stations 124 and load cups 123.

In some implementations, each carrier head 126 is coupled to a carriage 108 that is mounted to an overhead track 128. By moving a carriage 108 along the overhead track 128, the respective carrier head 126 can be positioned over a selected polishing station 124 or load cup 123. A carrier head 126 that moves along the overhead track 128 traverses the path past each of the polishing stations 124.

In the implementation shown in FIG. 1A, the overhead track 128 has a circular configuration (shown in phantom) which allows the carriages 108 retaining the carrier heads 126 to be selectively orbited over or clear of the load cups 123 and the polishing stations 124. The overhead track 128 may have other configurations including elliptical, oval, linear or other suitable orientation. Alternatively, in some implementations (not shown) the carrier heads 126 are suspended from a carousel, and rotation of the carousel moves all of the carrier heads 126 simultaneously along a circular path. Although the polishing apparatus illustrated herein is outfitted with an overhead track, the present disclosure may utilize any suitable polishing apparatus. In one example, the polishing apparatus may have a robot which provides the same functionality as the overhead track.

A controller 190, such as a programmable computer, is connected to respective motors to independently control the rotation rate of the platen 120 and the carrier heads 126 as described in more detail below. For example, each motor can include an encoder that measures the angular position or rotation rate of the associated drive shaft. Similarly, the controller 190 is connected to an actuator in each carriage 108 to independently control the lateral motion of each carrier head 126. For example, each actuator can include a linear encoder that measures the position of the carriage 108 along the overhead track 128.

The controller 190 includes a programmable central processing unit (CPU) 192, which is operable with a memory 194 (e.g., non-volatile memory) and support circuits 196. The support circuits 196 are conventionally coupled to the CPU 192 and comprise cache, clock circuits, input/output subsystems, power supplies, and the like, and combinations thereof coupled to the various components of the polishing apparatus 100. A user interface 198 is coupled to the controller 190 and is configured to transmit user input to the controller 190 and to display information to a user.

In some embodiments, the CPU 192 is one of any form of general purpose computer processor used in an industrial setting, such as a programmable logic controller (PLC), for controlling various monitoring system component and sub-processors. The memory 194, coupled to the CPU 192, is non-transitory and is typically one or more of readily available memory such as random access memory (RAM), read only memory (ROM), floppy disk drive, hard disk, or any other form of digital storage, local or remote.

Herein, the memory 194 is in the form of a computer-readable storage media containing instructions (e.g., non-volatile memory), that when executed by the CPU 192, facilitates the operation of the polishing apparatus 100. The instructions in the memory 194 are in the form of a program product such as a program that implements the methods of the present disclosure (e.g., middleware application, equipment software application, etc.). The program code may conform to any one of a number of different programming languages. In one example, the disclosure may be implemented as a program product stored on computer-readable storage media for use with a computer system. The program(s) of the program product define functions of the embodiments (including the methods described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure.

Although illustrated as a single computer, the controller 190 could be a distributed system, e.g., including multiple independently operating processors and memories. The computer architecture is adaptable to various polishing operations based on programming of the controller 190 to control the order and timing that the carrier heads are positioned at the polishing stations.

For example, a mode of operation is for the controller to cause a substrate to be loaded into a carrier head 126 at one of the load cups 123, and for the carrier head 126 to be positioned in turn at each polishing station 124a, 124b, 124c and 124d so that the substrate is polished at each polishing station in sequence. After polishing at the last station, the carrier head 126 is returned to one of the load cups 123 and the substrate is unloaded from the carrier head 126.

FIG. 1B is a schematic, partial cross-sectional side view of FIG. 1A illustrating an exemplary spray bar 134 in combination with polishing station 124. Each polishing station 124 of the polishing apparatus 100 includes a station cup 146 radially surrounding the platen 120. The station cup 146 has an inner sidewall surface 147 facing the platen 120. The inner sidewall surface 147 extends above a polishing surface 131 of the polishing pad 130 disposed on the platen 120. Slurry 135 from the polishing pad 130 contacts the inner sidewall surface 147 and collects inside the station cup 146. A drain 148 in the bottom of the station cup 146 or through the base 102 is used for draining slurry 135 collected inside the station cup 146.

The polishing apparatus 100 includes a plurality of cameras 150 for monitoring particular areas of interest within the polishing apparatus 100. The plurality of cameras 150 are configured to receive both video/image data streams and audio data streams. The plurality of cameras 150 are capable of transmitting the video and audio data streams in real-time to the controller 190.

Each of the plurality of cameras 150 may be mounted to a support (not shown) or coupled directly or indirectly to a respective component of the polishing apparatus 100. In some embodiments, each of the plurality of cameras 150 is fixed relative to the polishing apparatus 100. In some other embodiments, one or more of the plurality of cameras 150 are movable relative to the polishing apparatus 100 for repositioning or re-orienting the camera to change a field of view thereof. Further, each of the plurality of cameras 150 are coupled to and controlled by the controller 190.

Each of the plurality of cameras 150 may include a light source and an image sensor. Alternatively, the light source may be separate from the camera. For example, the light source may be a separate component of the polishing apparatus 100. In one example, the light source may comprise one or more light bars within the housing 101 of the polishing apparatus 100 for illuminating a processing region 105 of the polishing apparatus 100. Each of the plurality of cameras 150 may use a lens which is able to image an expanded field of view such as a wide-angle or fish-eye lens.

The polishing apparatus 100 may include a first camera 151 of the plurality of cameras 150 disposed above the carrier head 126. The first camera 151 may be coupled to at least one of the overhead track 128 or carriage 108 (shown in FIG. 1A). The position and orientation of the first camera 151 enables imaging of a surface of the carrier head 126, such as a surface of a housing 129 of the carrier head 126.

The polishing apparatus 100 may include a second camera 152 of the plurality of cameras 150 disposed above the polishing station 124. The second camera 152 may be coupled to at least one of an upper wall 103 or a sidewall 104 of the polishing apparatus 100. The position and orientation of the second camera 152 enables imaging of a surface of the carrier head 126 or a surface of one or more structures above the carrier head 126, such as the overhead track 128, a drive system 106 of the carrier head 126, or a drive shaft 107 of the carrier head 126.

The polishing apparatus 100 may include a third camera 153 of the plurality of cameras 150 disposed above a spray bar 134 of the polishing apparatus 100. The third camera 153 may be coupled to at least one of the upper wall 103, the sidewall 104, the overhead track 128, or the drive system 106. The position and orientation of the third camera 153 enables imaging of a surface of the spray bar 134, such as a surface of an arm 136 of the spray bar 134.

The polishing apparatus 100 may include a fourth camera 154 of the plurality of the plurality of cameras 150 disposed in the processing region 105, e.g., adjacent to the second camera 152. The fourth camera 154 may be coupled to at least one of the upper wall 103, the sidewall 104, the overhead track 128, or the drive system 106. The position and orientation of the fourth camera 154 enables imaging of a surface of the sidewall 104.

The polishing apparatus 100 may include a fifth camera 155 of the plurality of cameras 150 disposed above the station cup 146. The fifth camera 155 may be coupled to at least one of the overhead track 128, or the drive system 106. The position and orientation of the fifth camera 155 enables imaging of a surface of the station cup 146, such as the inner sidewall surface 147.

FIG. 1C is a schematic, partial cross-sectional side view of FIG. 1A illustrating an exemplary pad conditioning apparatus 112 in combination with polishing station 124. Each pad conditioning apparatus 112 includes an arm 113 which supports a conditioner head 115 over a respective platen 120. The arm 113 is rotatably secured to the base 102. A distal end of the arm 113 is coupled to a housing 116 of the conditioner head 115. A motor 117 is coupled to the distal end of the arm 113 for rotating the conditioner head 115 during pad conditioning. A proximal end of the arm 113 is coupled to a base 118 which extends upward from the base 102 of a housing 101 of the polishing apparatus 100. The base 118 is rotatable to pivot the arm 113 and laterally translate the conditioner head 115 across the polishing surface 131.

The polishing apparatus 100 may include a sixth camera 156 of the plurality of cameras 150 disposed above the pad conditioning apparatus 112. The sixth camera 156 may be coupled to at least one of the upper wall 103, sidewall 104, the overhead track 128, or drive system 106. The position and orientation of the sixth camera 156 enables imaging of a surface of the pad conditioning apparatus 112, such as a surface of the arm 113, the conditioner head 115, or the motor 117.

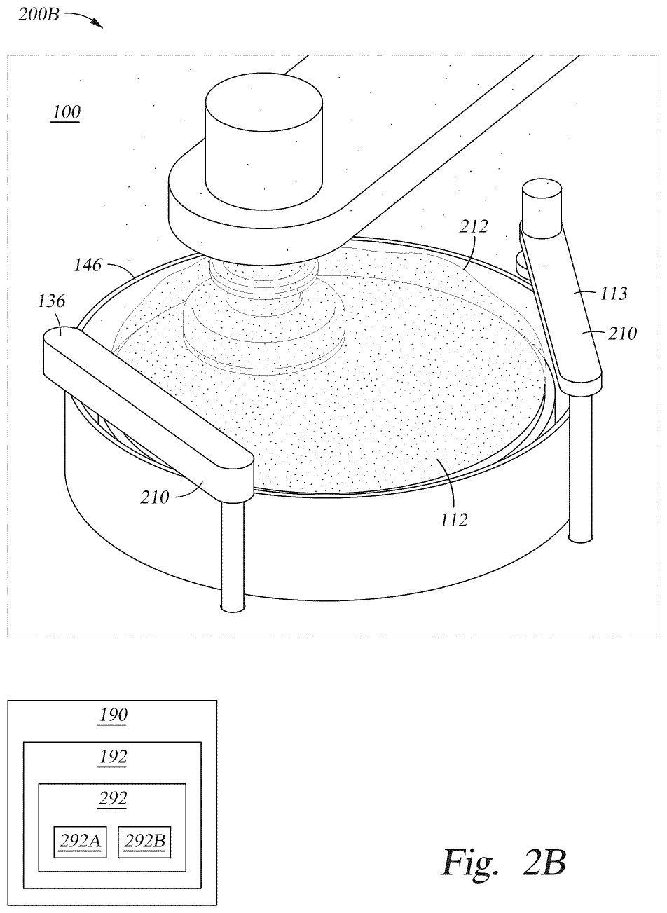

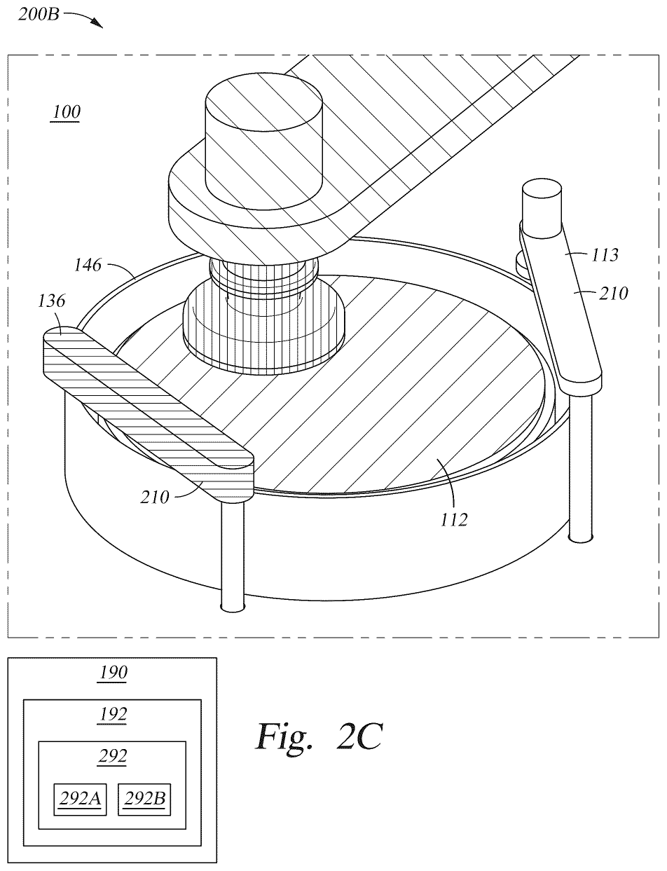

FIG. 2A illustrates a top-view of the polishing apparatus 100 under an object contouring process 200A. Object contouring involves detecting and recognizing the boundaries of objects in digital images. During the contouring process 200A, the camera provides image data streams to a media analysis processor 292, such as a video analysis processor 292A, in the controller 190. The controller 190 is configured to reconstruct parts of a plurality of contours 210 defined by the various components of the polishing apparatus (e.g., arm 113) by performing edge grouping or as parts of boundaries of segmented regions.

The controller 190 reconstructs the contours by using parallel algorithms with particular attention paid to local image analysis and a generalized eigensolver used in the process. Alternatively, the controller 190 may reconstruct the contours by using an active contour model (ACM) for image segmentation and object tracking.

An ACM may involve evolving a contour in images towards the boundaries of objects. The ACM may be based on techniques of curve evolution, Mumford-Shah functional for segmentation, and level sets. The ACM may be beneficial due to strong mathematical properties and efficient numerical schemes based on the level set method. The ACM may also include an integrated region-, boundary-, or shape-based active contour model for multiple object overlap resolution in histological imagery.

FIGS. 2B and 2C illustrate a top-view of the polishing apparatus 100 under an image segmentation process. More particularly, FIG. 2B illustrates a top-view of the polishing apparatus 100 under image segmentation 200B to detect abnormal environmental conditions such as the presence of steam. FIG. 2C illustrates a top-view of the polishing apparatus 100 under image segmentation 2000 to identify individual hardware components in the polishing apparatus.

In FIG. 2B, an image segmentation process 200B is used to detect abnormal environmental conditions in the polishing apparatus 100 by using object tracking. The image segmentation for object tracking includes dividing an image received by at least one of the plurality of cameras 150 into multiple segments or regions, with each segment corresponding to a different object or part of an object.

The image segmentation process 200B may include color segmentation, which detects moving objects based on color differences. Alternatively, optical flow and depth information based on the image data received can be used to detect moving objects by tracking the motion of individually tracked image points and segmenting them into objects using a globally optimal graph-cut algorithm. The controller 190 may use object tracking in the image segmentation process 200B to identify abnormal environmental conditions 212 within the polishing apparatus 100, such as steam within the pad conditioning apparatus 112.

As another alternative, the image segmentation process 200B may use cross-classification clustering to track interrelated objects in an image stack received by the sixth camera 156 (FIG. 1A). Seeded watersheds can also be used for combined segmentation and tracking of cells, where segmentation results from a previous time frame can be used as seeds for watershed segmentation of the current time frame.

In FIG. 2C, an image segmentation process 2000 can be used to detect obstructions or incorrect movements based on object tracking in the polishing apparatus 100. By detecting and tracking moving objects using image segmentation, obstructions or incorrect movements can be detected and corrected. Additionally, a line segment-based approach can be used for 3D motion estimation and tracking of multiple objects from a monocular image sequence. Moreover, the implementation architecture of image segmentation and pattern matching on FPGA/ASIC can also be used for object tracking.

The image segmentation process 2000 allows for object identification of different components of the polishing apparatus, such as the overhead track 128, the drive system 106, the arm 113, and the pad conditioning apparatus 112. Once the different components of the polishing apparatus 100 are identified, obstructions or incorrect movements may then be determined with continuous monitoring.

The video/image data gathered by the at least one of the plurality of cameras 150 may be used to detect improper hardware configuration that may not be readily evident with existing sensors. The present disclosure allows cameras within the polishing apparatus to be active components, rather than passive components, which reduce the required user intervention in identifying excursions when a failure mode occurs within the system.

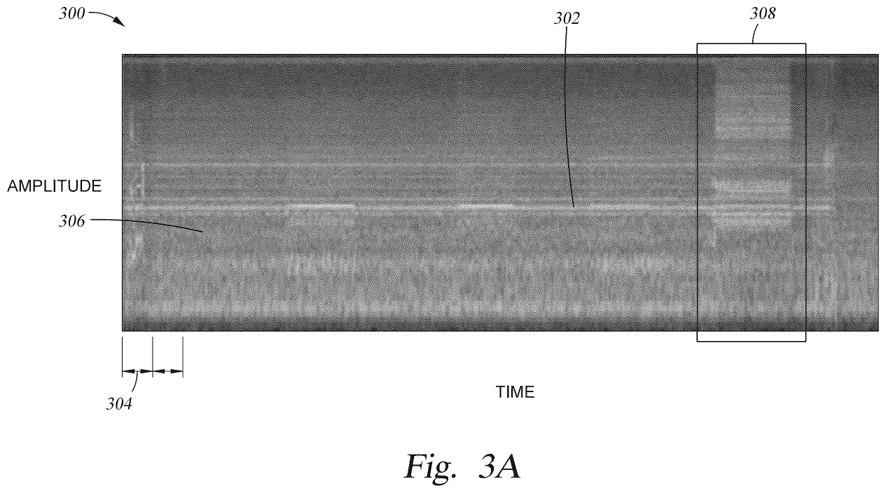

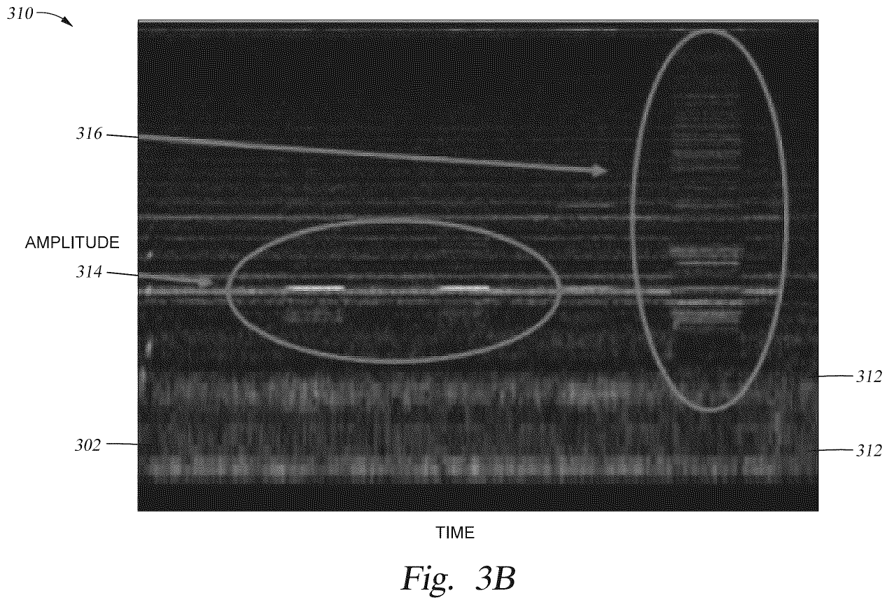

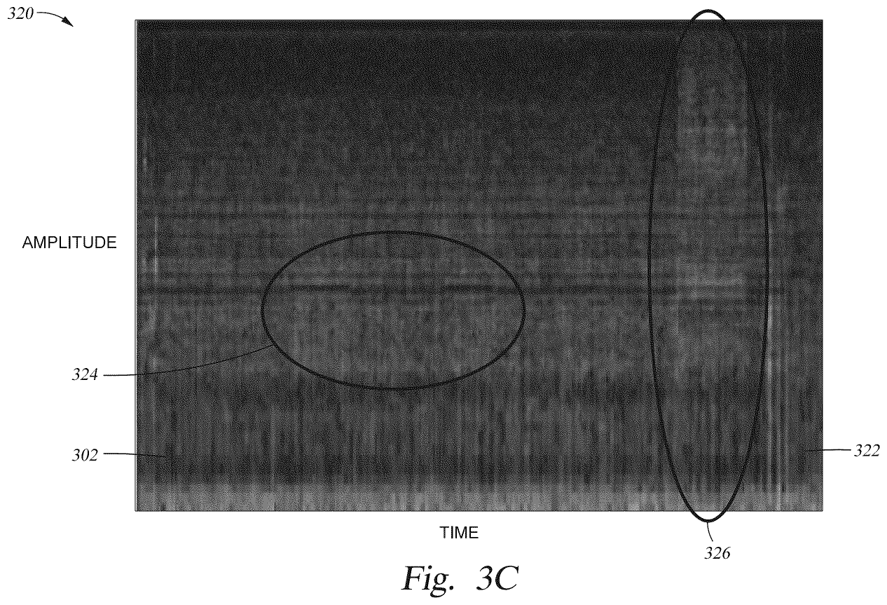

Regarding audio data processing in the media analysis processor 292, such as by an audio analysis processor 292B in the controller 190, FIGS. 3A-3C show example spectrograms from audio data received from the polishing apparatus 100. More particularly, FIG. 3A shows a normal spectrogram, FIG. 3B shows a harmonic spectrogram, and FIG. 3C shows a percussive spectrogram.

Audio processing involves the manipulation of audio signals to achieve a wide range of tasks, including filtering, data compression, speech processing, and noise suppression. The audio analysis processor 292B may be configured to perform a Fast Fourier Transform (FFT) analysis, which is used to analyze the frequency content of an audio signal received by the sixth camera 156 (FIG. 1A). The FFT analysis may divide a Discrete Fourier Transform (DFT) into smaller DFTs, allowing for more efficient computation. The use of FFT analysis also allows the audio analysis processor 292B to engage in machine learning and deep learning applications to extract features from the input audio data.

As shown in FIG. 3A, the audio analysis processor 292B (FIG. 2A) may be configured to produce a spectrogram 300 based on FFT analysis to analyze the frequency content of an audio signal 302 in small, overlapping time windows 304. The resulting frequency content is then plotted as a function of time, with the amplitude 306 of each frequency represented by a color or grayscale value. The audio analysis processor 292B may then use the spectrogram 300 to determine an anomaly or abnormal condition 308 based on the amplitude 306 of the audio signal 302 over a time window 304.

FIGS. 3B and 3C show example harmonic spectrogram 310 and percussive spectrogram 320. Harmonic spectrograms and percussive spectrograms are two types of spectrograms that are used in harmonic/percussive source separation (HSPS) of audio signals. During HPSS in the audio analysis processor 292B, the distinctive source-specific structures of power spectrograms are exploited to separate harmonic and percussive components of an audio signal using log-frequency spectrograms to allow shift invariance in frequency.

The audio analysis processor 292B (FIG. 2A) may perform HPSS to separate harmonic and percussive components of an audio signal received from an audio source (e.g., at least one of the plurality of cameras 150). The harmonic spectrogram 310 is used to extract harmonic components 312 of an audio signal 302, which are characterized by a fundamental frequency and its harmonics. The audio analysis processor 292B may then determine an abnormal condition by comparing a normal harmonic response 314 to a spiked or abnormal harmonic response 316 in the audio signal 302.

The percussive spectrogram 320, on the other hand, is used to extract percussive components 322 of an audio signal 302, characterized by transient audio data 324 and noisy audio data 326. The audio analysis processor 292B may then determine an abnormal condition based on the amplitude and frequency of the noisy audio data 326.

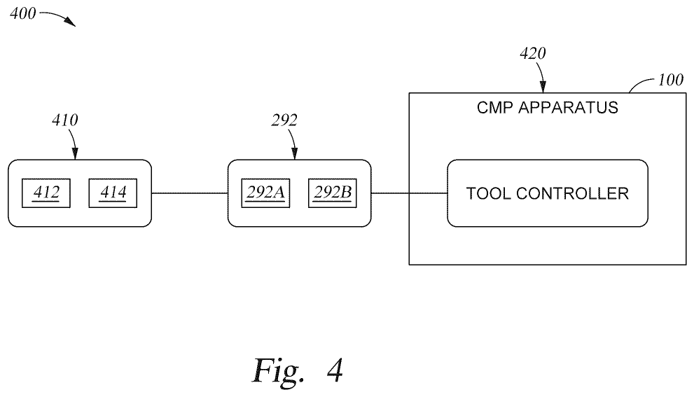

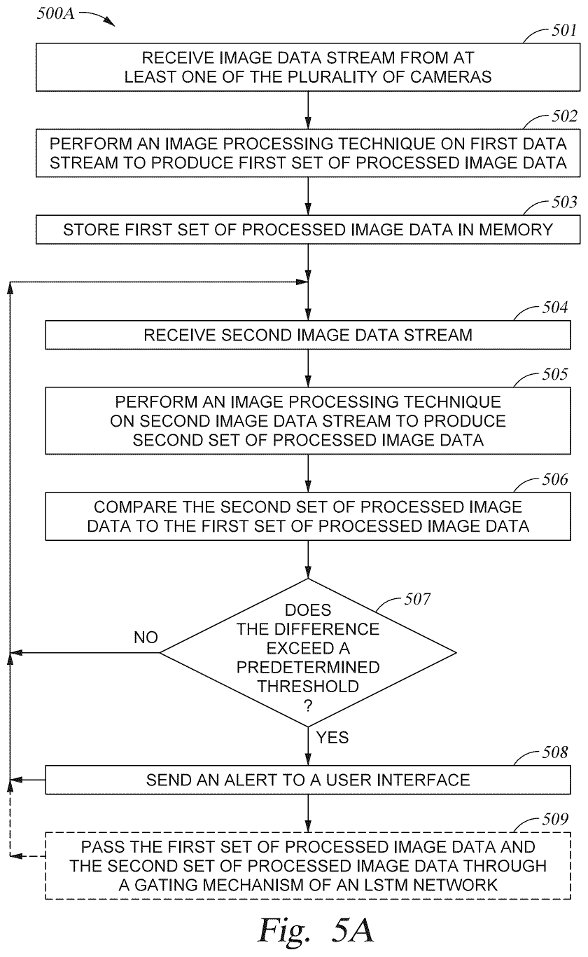

FIG. 4 shows an example real-time control scheme 400 for use with the polishing apparatus 100. The real-time control scheme 400 includes a media stream 410, such as a video data stream 412, an audio data stream 414, or both, from a media source (e.g., at least one of the plurality of cameras 150 (FIG. 1A)), a media analysis processor (e.g., media analysis processor 292) with a video analysis processor (e.g., video analysis processor 292A) and an audio analysis processor (e.g., audio analysis processor 292B) capable of processing video and image data, audio data, or a combination thereof. The real-time control scheme 400 includes a tool controller 420 within the polishing apparatus 100.

The control scheme 400 may intercept image and audio streams for real-time processing. Using the video analysis processor 292A and audio analysis processor 292B, the control scheme 400 may process the image and audio data through separate computing layers. For example, the control scheme 400 may use separate physical computers or separate digital signal processors to allow for faster processing of each of the image data stream and the audio data stream.

The control scheme 400 may embed trained artificial intelligence (AI) or machine learning (ML) inference models into the video analysis processor 292A, audio analysis processor 292B, or both to determine the health of the polishing apparatus 100 during operation. For example, the audio analysis processor 292B may include an AI/ML-based categorization method to classify audio signals based on their content. The categorization method may include audio tagging, acoustic scene classification, and sound event detection. The audio analysis processor 292B may also include a convolutional neural network (CNN) to extract features from a spectrogram (e.g., spectrogram 300) for audio tagging.

The control scheme 400 may also include a Long Short-Term Memory (LSTM) recurrent neural network (RNN) to overcome the vanishing gradient problem that occurs in traditional RNNs by using a gating mechanism to selectively remember or forget information over time. Using an LSTM network allows for accurate processing even with very long intervals and delays in a time series.

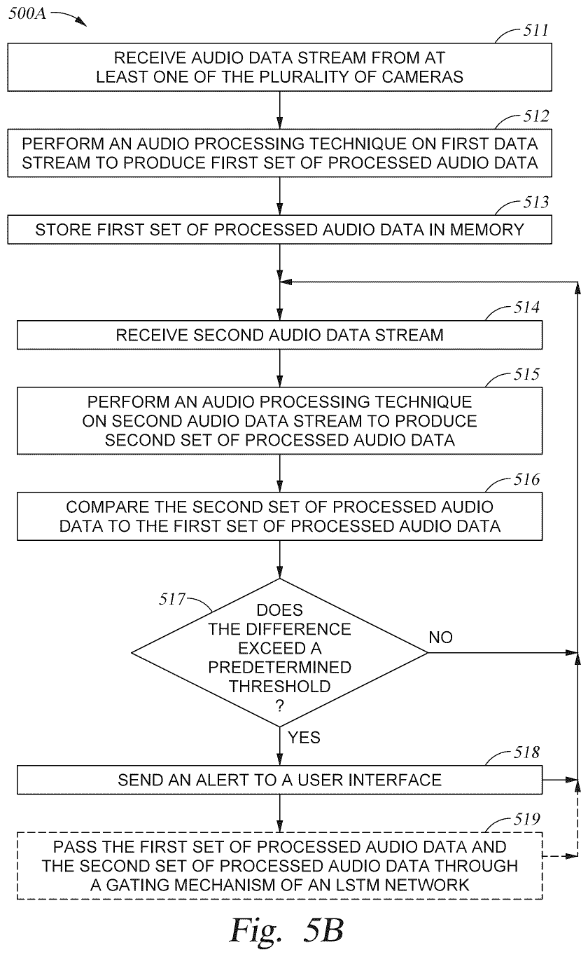

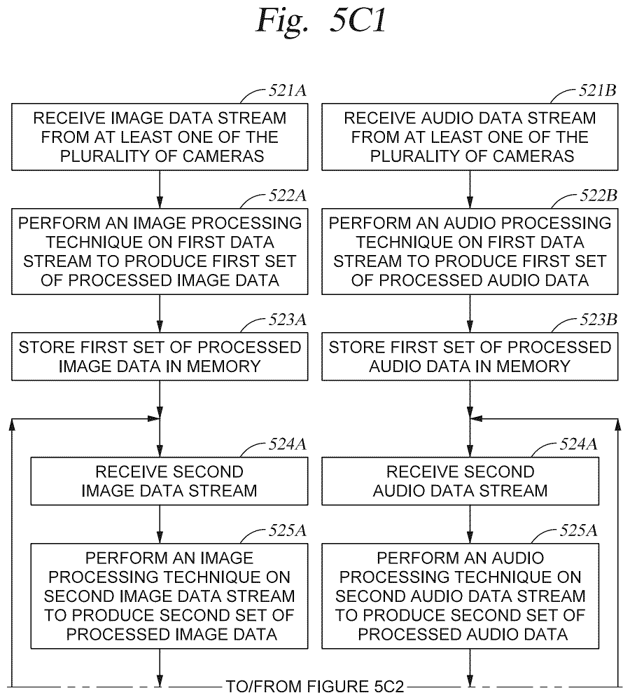

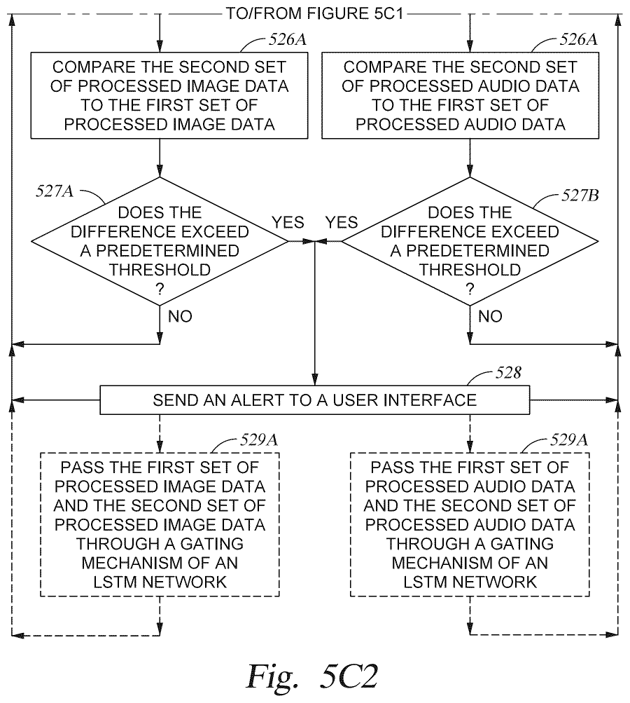

FIGS. 5A-5C2 illustrate methods of video processing, audio processing, or a combination thereof to monitor the polishing apparatus 100 for use with a real-time control scheme (e.g., real-time control scheme 400). More particularly, FIG. 5A illustrates a method of video processing for a polishing apparatus (e.g., polishing apparatus 100). FIG. 5B illustrates a method of audio processing for the polishing apparatus 100. FIGS. 5C1 and 5C2 illustrate a method for joint video and audio processing for the polishing apparatus 100.

In FIG. 5A, method 500A begins with the video analysis processor 292A in the controller 190 receiving image data from at least one of the plurality of cameras 150 in block 501. The controller 190, in block 502, performs an image processing technique on the image data. The image processing technique may include object contouring, image segmentation for object tracking, or a combination thereof to produce a first set of processed image data. The processed image data may be object contours corresponding to the various components of the CMP system, such as an arm (e.g., 113) of a polishing apparatus (e.g., polishing apparatus 112).

The video analysis processor 292A may then store the first set of processed image data in a memory (e.g., memory 194) in block 503. The video analysis processor 292A may then receive a second image data stream in block 504 before processing the subsequent image data in the video analysis processor 292A in block 505 to produce a second set of processed image data. The video analysis processor 292A may then, in block 506 compare the second set of processed image data to the first set of processed image data to detect anomalies.

The video analysis processor 292A detects an anomaly if the second set of processed image data differs from the first set of processed image data by a predetermined threshold in block 507. The predetermined threshold may include a percentage difference, a value difference, or a satisfactory range. For example, if the contours of the second set of processed image data differs in position from the contours of the first set of processed image data by more than 10%, more than 5%, or more than 3%, the video analysis processor 292A determines that the predetermined threshold is exceeded. The predetermined threshold may correspond to excessive vibration of a component (e.g., the arm 113) of the polishing apparatus 100, abnormal environment conditions such as steam present in the polishing apparatus 100, or any other desired anomaly. In block 508, if the video analysis processor 292A determines that the predetermined threshold is exceeded, the controller may send an alert to a user interface 198 coupled to the controller 190.

Alternatively, each of the first set of processed image data and subsequent sets of processed image data may be compared to baseline image data stored in the memory 194. The baseline image data may include previous image data collected under normal operation of a CMP system.

The method 500A then returns to block 504 for continuous system monitoring. In an LTSM application, the method 500A includes an additional block 509 in which the second set of processed image data is passed through a gating mechanism, such as an input gate, an output gate, and a forget gate, and stored or forgotten according to the ongoing allocated weights of the LSTM network.

The method 500A enables object contouring to identify various hardware components of the CMP system and detect anomalies in the CMP environment.

In FIG. 5B, method 500B begins with receiving audio data from at least one of the plurality of cameras 150 to the audio analysis processor 292B in the controller 190 in block 511. The controller 190, in block 512, performs an audio processing technique on the audio data. The audio processing technique may include FFT analysis, HPSS, or a combination thereof to produce a first set of processed audio data. The processed audio data may be a normal spectrogram, a harmonic spectrogram, a percussive spectrogram, or a combination thereof correlating to the sound produced within the CMP system.

The audio analysis processor 292B may then store the first set of processed audio data in a memory (e.g., memory 194) in block 513. The audio analysis processor 292B may then receive subsequent audio data before processing the subsequent audio data in the audio analysis processor 292B in block 514 to produce a second set of processed audio data. The audio analysis processor 292B may then, in block 515 compare the second set of processed audio data to the first set of processed audio data to detect anomalies.

The audio analysis processor 292B detects an anomaly if the second set of processed audio data differs from the first set of processed audio data by a predetermined threshold in block 516. The predetermined threshold may include a percentage difference, a value difference, or a satisfactory range. For example, if the contours of the second set of processed audio data differs in position from the contours of the first set of processed audio data by more than 10%, more than 5%, or more than 3%, the audio analysis processor 292B determines that the predetermined threshold is exceeded. The predetermined threshold may correspond to a state of a consumable (e.g., the polishing pad) of the polishing apparatus 100, tool failure within the polishing apparatus 100, or any other desired anomaly. In block 517, if the audio analysis processor 292B determines that the predetermined threshold is exceeded, the controller may send an alert to a user interface 198 coupled to the controller 190.

Alternatively, each of the first set of processed audio data and subsequent sets of processed audio data may be compared to baseline audio data stored in the memory 194. The baseline audio data may include previous audio data collected under normal operation of a CMP system.

The method 500B then returns to block 514 for continuous system monitoring. In an LTSM application, the method 500B includes an additional block 518 in which the second set of processed audio data is passed through an input gate, an output gate, and a forget gate and stored or forgotten according to the ongoing allocated weights of the LSTM network.

The method 500B allows for monitoring of CMP system frequency patterns to detect anomalies in the CMP environment as well as determine the state of consumable lifetime. For example, a polishing pad may produce sound at a certain frequency when it is at the beginning of its lifetime. As the polishing pad wears down, the frequency it produces during the CMP process shifts. The method 500B may determine the shift in this example frequency and send an alert when the target frequency of a polishing pad near the end of its lifetime is reached.

In FIG. 5C1, method 5000 begins with receiving image data and image data from at least one of the plurality of cameras 150 to the video analysis processor 292A and the audio analysis processor 292B in the controller 190 in block 521A and 521B, respectively. The controller 190, in block 522A, performs an image processing technique on the image data to produce a first set of processed image data as previously discussed in the method 500A. The controller 190, in block 522B, performs an audio processing technique on the audio data to produce a first set of processed audio data as discussed in the method 500B.

The video analysis processor 292A may then store the first set of processed image data in a memory (e.g., memory 194) in block 523A. The video analysis processor 292A may then receive subsequent image data in block 524A before processing the subsequent image data in the video analysis processor 292A in block 525A to produce a second set of processed image data. The video analysis processor 292A may then, in block 526A compare the second set of processed image data to the first set of processed image data to detect anomalies as discussed in the method 500A.

The audio analysis processor 292B may store the first set of processed audio data in a memory (e.g., memory 194) in block 523B. The audio analysis processor 292B may then receive subsequent audio data in block 524B before processing the subsequent audio data in the audio analysis processor 292B in block 525B to produce a second set of processed audio data. The audio analysis processor 292B may then, in block 526B compare the second set of processed audio data to the first set of processed audio data to detect anomalies as discussed in the method 500B.

As shown in FIG. 5C2, the method 5000 continues as the controller 190 then compares any anomaly detected by the video analysis processor 292A to any anomaly detected by the audio analysis processor 292B and vice versa in block 527. The controller 190 may then determine if the anomaly detected by the audio analysis processor 292B validates the anomaly detected by the video analysis processor 292A or vice versa. For example, if the video analysis processor 292A detects failure of a tool (e.g., the arm 113), the controller 190 may validate this anomaly with spikes in a percussive spectrogram data provided by the audio analysis processor 292B. Alternatively, the controller 190 may determine that an anomaly is present if either the video analysis processor 292A or the audio analysis processor 292B detect an anomaly.

The controller 190 then, in block 528, sends an alert to a user interface 198 coupled to the controller 190. The alert may correspond to the combined or individual anomalies.

The method 5000 then returns to block 524A and 524B for continuous system monitoring. In an LTSM application, the method 5000 includes an additional block 529A and 529B in which the second set of processed image data and the second set of processed audio data are passed through their system's respective input gate, an output gate, and a forget gate and stored or forgotten according to the ongoing allocated weights of the LSTM network. The method 5000 enables real-time visual and audio information to be used to determine and predict substrate process state to control processing.

The present disclosure provides new systems and methods for video/image and audio data usage to complement preexisting data streams mined from sensors and motors. Visual detection during process as well as monitoring tool condition enables improved tool health maintenance, such as tool cleanliness or detection of foreign objects within the system. Environment audio captured may provide additional insight on process states. The present disclosure also enables sensors to be consolidated.

When introducing elements of the present disclosure or exemplary aspects or embodiment(s) thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another—even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. A polishing apparatus, comprising:
an arm rotatably secured to a base of the polishing apparatus;
a conditioning head coupled to the arm and configured to rotate over a platen;
at least one camera positioned within the polishing apparatus; and
a controller coupled to the at least one camera, the controller comprising a memory and a media analysis processor, the controller configured to:
receive a media data stream from the at least one camera;
process the media data stream into processed media data; and
detect an anomaly in the polishing apparatus based on the processed media data.

2. The polishing apparatus of claim 1, wherein the media analysis processor is a video analysis processor, the media data stream is an image data stream, and the processed media data is processed image data.

3. The polishing apparatus of claim 2, wherein the video analysis processor is configured to process the image data stream using object contouring.

4. The polishing apparatus of claim 3, wherein the processed image data includes a first set of processed image data and a second set of processed image data, and wherein the controller is configured to detect the anomaly by comparing the second set of processed image data to the first set of processed image data.

5. The polishing apparatus of claim 1, wherein the media analysis processor is an audio analysis processor, the media data stream is an audio data stream, and the processed media data is processed audio media data.

6. The polishing apparatus of claim 5, wherein the audio analysis processor is configured to process the audio data stream using Fast Fourier Transform analysis.

7. The polishing apparatus of claim 6, wherein the processed audio data includes a first set of processed audio data and a second set of processed audio data, and wherein the controller is configured to detect the anomaly by comparing the second set of processed audio data to the first set of processed audio data.

8. A method of monitoring a polishing apparatus, comprising:
receiving a first image data stream from a camera disposed in the polishing apparatus;
processing the first image data stream using a video analysis processor of a controller coupled to the polishing apparatus to produce a first set of processed image data;
receiving a second image data stream from the camera;
processing the second image data stream using the video analysis processor to produce a second set of processed image data;
comparing the second set of processed image data to the first set of processed image data to determine if a predetermined threshold is exceeded; and
upon determining that the predetermined threshold is exceeded, transmitting an alert to a user interface coupled to the controller.

9. The method of claim 8, further comprising passing the first set of processed image data and the second set of processed image data through a gating mechanism of a long short-term memory neural network.

10. The method of claim 8, wherein processing the first image data stream includes performing an object contouring process such that reconstructed contours are defined by components of the polishing apparatus.

11. The method of claim 8, wherein processing the first image data stream includes performing image segmentation using a line-segment based approach.

12. The method of claim 8, wherein the predetermined threshold corresponds to abnormal environment conditions within the polishing apparatus.

13. The method of claim 8, wherein the predetermined threshold corresponds to excessive vibration of a component of the polishing apparatus.

14. The method of claim 8, wherein processing the first image data stream includes using cross-classification clustering to track interrelated objects in the polishing apparatus.

15. A method of monitoring a polishing apparatus, comprising:
receiving a first audio data stream from a camera disposed in the polishing apparatus;
processing the first audio data stream using an audio analysis processor of a controller coupled to the polishing apparatus to produce a first set of processed audio data;
receiving a second audio data stream from the camera;
processing the second audio data stream using the audio analysis processor to produce a second set of processed audio data;
comparing the second set of processed audio data to the first set of processed audio data to determine if a predetermined threshold is exceeded; and
upon determining that the predetermined threshold is exceeded, transmitting an alert to a user interface coupled to the controller.

16. The method of claim 15, further comprising passing the first set of processed audio data and the second set of processed audio data through a gating mechanism of a long short-term memory neural network.

17. The method of claim 15, wherein processing the first audio data stream includes performing a Fast Fourier Transform analysis.

18. The method of claim 15, wherein processing the first audio data stream includes performing harmonic percussive source separation, and wherein the first set of processed audio data comprises harmonic spectrogram data, percussive spectrogram data, or both.

19. The method of claim 15, wherein the first set of audio data corresponds to a state of a consumable within the polishing apparatus.

20. The method of claim 15, wherein the predetermined threshold corresponds to tool failure within the polishing apparatus.
